(19) United States
(12) Patent Application Publication
(10) Pub. No.: US 2014/0163709 A1
(43) Pub. Date: Jun. 12, 2014

(54) EMBEDMENT POSITIONING SYSTEM

(71) Applicant: lllinois Tool Works Inc., Glenview, IL (US)

(72) Inventors: Larry Moeller, Schaumburg, IL (US); Daniel Dina, North Barrington, IL (US); William Todd Watson, Mount Prospect, IL (US); George Matthew Davis, Chicago, IL (US)

(73) Assignee: lllinois Tool Works Inc., Glenview, IL (US)

(21) Appl. No.: 14/095,039

(22) Filed: Dec. 3, 2013

Related U.S. Application Data
(60) Provisional application No. 61/734,710, filed on Dec. 7, 2012.

(51) Int. Cl. G05B 15/02

(52) U.S. Cl. CPC G05B 15/02
USPC 700/97

(57) ABSTRACT

Various embodiments of the present disclosure provide an embedment positioning system that facilitates the positioning of a plurality of embedments along an edge of a concrete form. In one embodiment, the present disclosure provides an embedment positioning tape formed with embedment position indicators indicating the positions at which a plurality of embedments are to be positioned along a concrete form. In operation, a user unrolls and attaches the embedment positioning tape along the concrete form such that the control line location indicator lines up with the actual control line. The user then uses the embedment positioning indicators to position the embedments at the correct positions along the edge of the concrete form without having to hand-measure those positions for each embedment. The present disclosure also provides an embedment positioning tape forming system and method.

### PRIORITY CLAIM

This application claims priority to and the benefit of U.S. Provisional Patent Application No. 61/734,710, filed on Dec. 7, 2012, the entire contents of which are incorporated herein by reference.

### BACKGROUND

Building envelopes of certain commercial and mixed use residential buildings include a curtain wall. The curtain wall of a building defines the appearance of the building and, more importantly, separates the interior controlled or conditioned space from the outside environment. The curtain wall is usually formed from a plurality of curtain wall panels that typically contain glass, metal, and/or stone. The curtain wall panels are attached to the building's structural elements via anchors and curtain wall panel hanging brackets (sometimes referred to as curtain wall panel brackets or panel brackets). The anchors are located at discrete attachment points along the edges of the building's concrete floor slabs. The anchors typically include embedments (sometimes referred to as embeds) that are each cast into a concrete floor slab and that may be located on the top of the slab, on the face of the slab, or beneath the slab. A panel bracket is attached to each embedment, and a curtain wall panel is hung from each panel bracket.

For a given concrete floor slab, before the concrete that forms that concrete floor slab is poured into the concrete form, an array of rebar, metallic cables, and/or other material used to reinforce the concrete floor slab is installed within the concrete form. Embedments are then positioned along an edge of the concrete form by a one or more workers using a tape measure and control lines provided by the general contractor. That is, the worker typically uses the tape measure to hand measure where to position each embedment along the edge of the concrete form using the control lines for reference, though in certain instances the embedments are positioned along the edge of the concrete form with the aid of survey equipment.

This installation process requires another measurement by the worker to assure the embedment has the proper edge spacing from the concrete form (i.e., to ensure the embedment is located at the proper distance from the edge of the concrete form). More specifically, after determining the position along the edge of the concrete form at which to attach the embedment, the worker must then use the tape measure to hand measure the distance of the embedment from the edge of the concrete form. The worker then anchors the embedment into place by either nailing the embedment to the concrete form, wire tying the embedment to rebar, or wire tying the embedment to scraps of lumber and then nailing the lumber to the concrete form such that the anchored embedment has the proper edge spacing from, and is positioned at the desired position along the edge of, the concrete form.

Concrete is then poured into the concrete form, typically via a high pressure concrete pumping hose. Concrete pumping hoses are heavy and unwieldy, and typically require multiple workers to control and operate the concrete pumping hose while walking on and around the rebar, metallic cables, and/or other reinforcing materials within the concrete form. As and after the concrete is being poured (pumped) into the concrete form, several workers level the poured concrete, which again involves the workers walking on and around the rebar, metallic cables, and/or other reinforcing materials. This movement, shifting, and jostling of the rebar, metallic cables, and/or other reinforcing materials, along with the vibration of the concrete pumping hose and the movement of the poured concrete itself, is problematic because it may alter the position of one or more of the embedments or dislodge one or more of the embedments.

Sometime after the concrete has been poured, each embedment must be located and exposed, which sometimes requires workers to chip away any concrete that may be covering the embedment. After the embedments are located and exposed, a survey is conducted to determine whether any of the embedments are potentially problematic. More specifically, the survey is conducted to determine whether any embedments are missing, any embedments are buried too deep within the concrete floor slab, any embedments are improperly positioned or misaligned, and/or whether any embedments conflict with other features of the building, in which case a panel bracket may not be able to be safely or properly mounted to that embedment. After the survey is completed, any problematic embedments must be fixed before construction can continue.

After any problematic embedments are fixed, workers mount a separate, individual panel bracket to each embedment using fasteners. Certain curtain wall panels include attachment fixtures that “hang” onto the panel brackets such that the curtain wall panels hang off of the panel brackets. These attachment fixtures often include a mechanism that enables some level adjustment to aid in leveling the curtain wall panels. These leveling mechanisms are seldom used, however, because they increase the time it takes to the hang the curtain wall panels, thereby increasing installation costs due to labor and equipment (such as cranes). As a result, the panel brackets are usually leveled per floor prior to the installation of the curtain wall panels. More specifically, for each floor of the building, the panel brackets on that floor are leveled relative to one another such that they are all planar and at a same elevation to ensure that the installed curtain wall will be level after the curtain wall panels are craned into position. After the individual panel brackets are leveled, workers hoist the individual curtain wall panels and hang them onto the panel brackets at their respective final positions. The workers typically use a tower crane, truck crane, or mini crane to hoist and maneuver the curtain wall panels.

This above-described method of determining the desired embedment positions via hand-measurement is problematic and can result in a variety of different forms of human error. Specifically, the use of a tape measure to measure the desired positions of the embedments along the edge of the concrete form relative to the control lines can result in mismeasurement due to a misplaced control line, a misused tape measure (such as the end of the tape measure being incorrectly positioned), or a misread of the tape measure. Sometimes a worker will determine a position of an embedment by measuring from a previously-positioned embedment rather than from the control line, which can result in accumulative positioning errors if the first-positioned embedment is misplaced, which could result in every embedment being misplaced. Each improperly positioned embedment must be identified and repositioned, which increases construction time and associated labor costs.

Further, once the embedments are positioned and attached to the concrete form, the embedments are inherently unstable before, during, and after the workers pour the concrete into the form. As noted above, the concrete is poured via a high-pressure concrete pumping hose, and the force of the pumped concrete could move an embedment out of place or out of level. Additionally, the workers move around and on the rebar, metallic cables, and/or other reinforcing materials while pouring the concrete, which could cause an embedment to move out of place or out of level. Accordingly, the location and level of each embedment must be verified after the concrete is cured to ensure that the embedments are still in the correct positions and level. It is time-prohibitive for workers to manually verify that each embedment is at its proper position and level.

There is a need for new apparatuses and methods for positioning embedments along concrete forms, verifying the locations of the embedments, and verifying whether the embedments are level that solve the above problems.

### SUMMARY

Various embodiments of the present disclosure provide an embedment positioning system that facilitates the positioning of one or more embedments along an edge of a concrete form.

In one embodiment, the present disclosure provides an embedment positioning tape housed within a housing or cover. The embedment positioning tape is formed (such as by printing) with embedment position indicators indicating the positions at which a plurality of different embedments are to be positioned along a concrete form and with a control line location indicator that indicates the location of a control line. In operation, a user (such as a worker) unrolls the embedment positioning tape and attaches the embedment positioning tape along an edge of the concrete form such that the control line location indicator lines up with the actual control line provided by the general contractor. Once the embedment positioning tape is attached to the edge of the concrete form, the user uses the embedment positioning indicators to easily position the embedments at the correct positions along the edge of the concrete form without having to hand-measure those positions for each individual embedment.

In one embodiment, the present disclosure provides a system and method for forming the embedment positioning tape. In one embodiment, the embedment positioning tape forming system includes: (a) at least one central server, central controller, or remote host, which includes one or more central processing units and one or more memory devices; and (b) at least one embedment positioning tape printer. In this embodiment, the server is configured to communicate over a network with a plug-in of a software program installed on a user device. In operation of this embodiment, a user of the user device executes the software program to create one or more architectural drawings indicating the positions of one or more embedments along a concrete form, and saves the one or more architectural drawings as one or more electronic architectural drawing files on the user device. Thereafter, the software plug-in extracts embedment positioning information associated with the positions of the one or more embedments along the concrete form from the electronic architectural drawing files, and creates a data file representing the embedment positioning information. The user device sends the data file to the server over the network. The server receives the data file from the user device; processes the received data file; and determines, for each of the one or more embedments, a desired position of that embedment along the concrete form. The server causes the embedment positioning tape printer to print the desired positions of the one or more embedments along the concrete form on an embedment positioning tape. The embedment positioning tape is then sent or otherwise provided to the user.

In another embodiment, instead of (or in addition to) employing the software plug-in, the embedment positioning tape forming system is configured to employ a website and/or an executable application that is accessible by the user via the user device. The website or application enables the user to use the embedment positioning tape forming system to cause the embedment positioning tape to be formed. In operation of this embodiment, the user executes the software program to create one or more architectural drawings indicating the positions of one or more embedments along a concrete form, and saves the one or more architectural drawings as one or more electronic architectural drawing files on the user device. Thereafter, the website or application enables the user to upload the electronic architectural drawing file(s) directly to the server over the network. After receiving the uploaded electronic architectural drawing file(s), the server extracts embedment positioning information from the electronic architectural drawing file(s). The embedment positioning information is associated with the positions of the one or more embedments along the concrete form. Using the extracted embedment positioning information, the server determines, for each of the one or more embedments, a desired position of that embedment along the concrete form. The server causes the printer to print the desired positions of the one or more embedments along the concrete form on an embedment positioning tape. The embedment positioning tape is then sent or otherwise provided to the user.

In another embodiment, the present disclosure provides a plurality of embedment markers attachable to one or more embedments such that after those embedments are attached to a concrete form, the embedment markers act as visual indicators of the positions of the embedments. This enables quick and easy verification of the total number of embedments as well as the positions of those embedments along the edge of the concrete form. In certain embodiments, each embedment marker includes a level sensor configured to detect a level of that embedment marker.

In another embodiment, the present disclosure provides an embedment positioning system that includes a base transmitter unit, a receiver, and a plurality of embedments each including one or more targets. In operation, a user brings an embedment to the general position at which the embedment is to be positioned along the edge of the concrete form. The base transmitter unit sends a signal (such as a laser signal) to the embedment as the user moves the embedment along the edge of the concrete form. The user moves the embedment along the edge of the concrete form until the target on the embedment lights up, glows, or otherwise provides an indication. When the target on the embedment provides this indication, the user attaches the embedment to the concrete form. The indication thus notifies the user that the embedment is at the correct position along the edge of the concrete form.

Additional features and advantages of the present invention are described in, and will be apparent from, the following Detailed Description and the Figures.

### BRIEF DESCRIPTION OF THE FIGURES

FIG. 1A illustrates perspective views of one embodiment of the embedment positioning tape of the present disclosure.

FIG. 1B illustrates a block diagram of one embodiment of the embedment positioning tape forming system of the present disclosure.

FIG. 1C illustrates a flowchart of one embodiment of the method for forming the embedment positioning tape of the present disclosure.

FIG. 1D illustrates a flowchart of another embodiment of the method for forming the embedment positioning tape of the present disclosure.

FIG. 2 illustrates perspective views of one embodiment of the embedment markers of the present disclosure.

FIG. 3 illustrates perspective views of one embodiment of the embedment positioning system of the present disclosure.

FIG. 4 illustrates perspective views of another embodiment of the embedment positioning system of the present disclosure.

### DETAILED DESCRIPTION OF EXAMPLE EMBODIMENTS

Various embodiments of the present disclosure provide an embedment positioning system that facilitates the positioning of one or more embedments along an edge of a concrete form.

### Embedment Positioning Tape

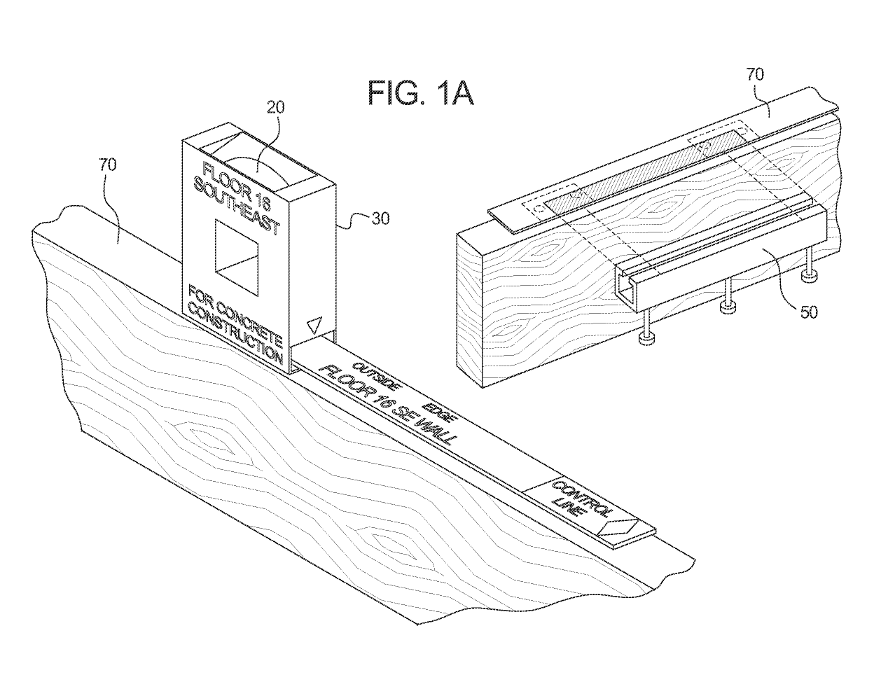

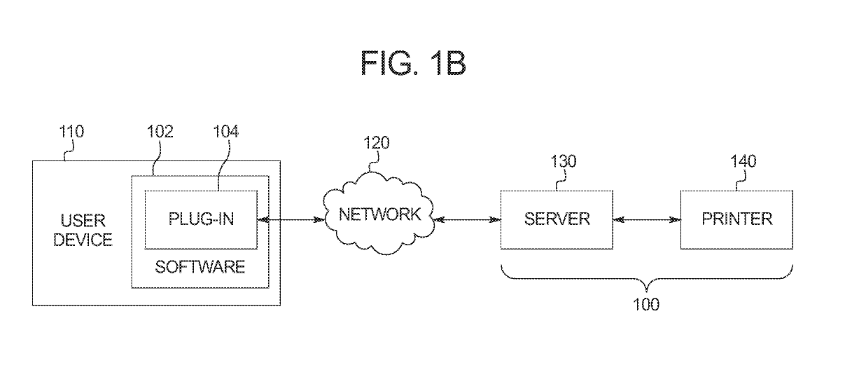

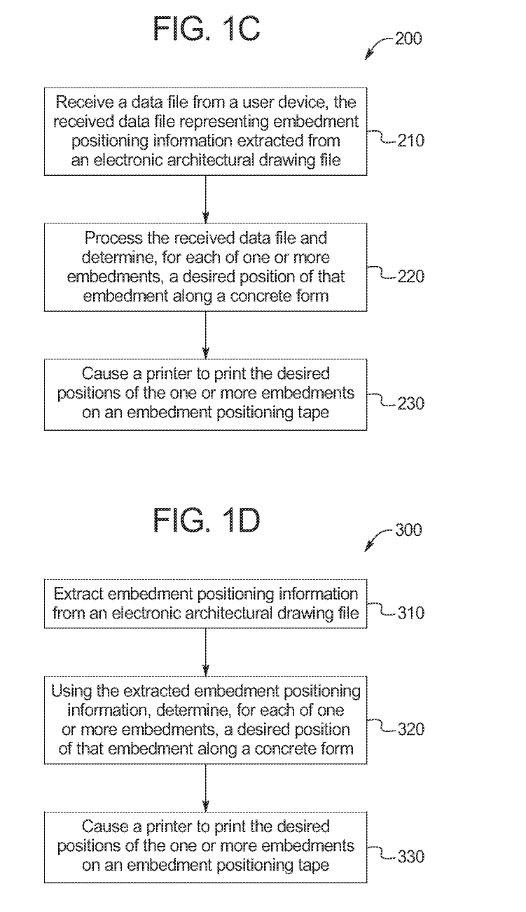

Turning now to the Figures and particularly to FIG. 1A, in one embodiment, the present disclosure provides an embedment positioning tape, which is generally indicated by numeral 20. The embedment positioning tape is housed within a housing or cover 30. The embedment positioning tape 20 is formed (such as by printing) with embedment position indicators indicating the positions at which a plurality of different embedments (such as embedment 50) are to be positioned along a concrete form (such as concrete form 70). The embedment positioning tape 20 is also formed (such as by printing) with a control line location indicator that indicates the location of a control line.

In operation, a user (such as a worker) unrolls the embedment positioning tape 20 and attaches the embedment positioning tape 20 along an edge of the concrete form 70 such that the control line location indicator lines up with the actual control line provided by the general contractor. This enables the user to ensure that the embedment positioning tape is accurately positioned on the edge of the concrete form. Once the embedment positioning tape is attached to the edge of the concrete form, the user uses the embedment positioning indicators to easily position the embedments at the correct positions along the edge of the concrete form without having to hand-measure those positions for each individual embedment. Additionally, the user may use the embedment positioning tape to verify whether the embedments are in the correct positions along the concrete form edge both before and after the concrete is poured.

It should be appreciated that the embedment positioning tape may be attached to the edge of the concrete form in any suitable manner, such as via staples, adhesive, or magnets. It should also be appreciated that the embedment positioning tape may be formed offsite and delivered to the jobsite on an as-needed basis or that the embedment positioning tape may be formed on the jobsite. It should further be appreciated that the embedment positioning tape is made of a durable, non-stretch, and weatherproof material.

The embedment positioning tape of the present disclosure solves certain of the above-described problems. The embedment positioning tape highlights precisely where the embedments are to be positioned along the edge of the concrete form, which eliminates the need for a user to use a tape measure to hand-measure the positions of the embedments and, therefore, eliminates the potential for human error in those measurements. The embedment positioning tape thus eliminates the time required to make such measurements as well as the associated labor costs. Further, the embedment positioning tape enables users to quickly and easily verify whether the embedments are in the correct positions along the edge of the concrete form before and after the concrete is poured.

Various embodiments of the present disclosure provide a system and method for forming the embedment positioning tape. FIG. 1B illustrates a block diagram of one embodiment of the embedment positioning tape forming system 100. In this illustrated embodiment, the embedment positioning tape forming system 100 includes: (a) at least one central server, central controller, or remote host 130, which includes one or more central processing units and one or more memory devices (as described in detail below); and (b) at least one embedment positioning tape printer 140. In this illustrated embodiment, as described in detail below, the server 130 is configured to communicate over a network 120 with a plug-in 104 of a software program 102 installed on a user device 110. It should be appreciated that the user device may be any suitable computing device, such as (but not limited to) a desktop computer, a laptop computer, a tablet computer, a personal digital assistant (PDA), and a cell phone (such as a smartphone).

FIG. 1C illustrates a flowchart of an example process or method 200 of operating the embedment positioning tape forming system 100. In various embodiments, the process 200 is represented by a set of instructions stored in one or more memories and executed by one or more processors. Although the process 200 is described with reference to the flowchart shown in FIG. 1C, it should be appreciated that many other processes of performing the acts associated with this illustrated process may be employed. For example, the order of certain of the illustrated blocks may be changed, certain of the illustrated blocks may be optional, and/or certain of the illustrated blocks may not be employed.

In operation of this embodiment, a user of the user device 110 executes the software program 102 to create one or more architectural drawings, such as shop drawings, indicating (among other features) the positions of one or more embedments along a concrete form, and saves the one or more architectural drawings as one or more electronic architectural drawing files on the user device 110. Thereafter, the software plug-in 104 extracts embedment positioning information associated with the positions of the one or more embedments along the concrete form from the electronic architectural drawing files, and creates a data file representing the embedment positioning information. The user device 110 sends the data file to the server 130 over the network 120. As indicated by block 210, the server 130 receives the data file from the user device 110. The server 130 processes the received data file and determines, for each of the one or more embedments, a desired position of that embedment along the concrete form, as indicated by block 220. The server 130 causes the embedment positioning tape printer 140 to print the desired positions of the one or more embedments along the concrete form on an embedment positioning tape, as indicated by block 230. The embedment positioning tape is then sent or otherwise provided to the user.

In various embodiments, instead of (or in addition to) employing the software plug-in, the embedment positioning tape forming system is configured to maintain and provide a website that is accessible by the user via the user device. The website includes a system user interface (system UI) that enables the user to, after accessing the website using the user device, use the embedment positioning tape forming system to cause the embedment positioning tape to be formed. In other embodiments, the embedment positioning tape forming system employs one or more applications (commonly referred to as “apps”) downloaded to the user's user device. In one example, the user opens or launches an application on the user's tablet computing device or smartphone (i.e., the user's user device), and the application provides the user access to the system UI (which may be the same as the system UI provided on the website or a modified system UI optimized for mobile use). Thus, in these embodiments, the user is not required to navigate to any website to access the system UI and cause the embedment positioning tape to be formed. In one embodiment, the embedment positioning tape forming system enables a user to purchase a “premium” or “upgraded” application that includes additional features or functionality.

FIG. 1D illustrates a flowchart of an example process or method 300 of operating this embodiment of the embedment positioning tape forming system. In various embodiments, the process 300 is represented by a set of instructions stored in one or more memories and executed by one or more processors. Although the process 300 is described with reference to the flowchart shown in FIG. 1D, it should be appreciated that many other processes of performing the acts associated with this illustrated process may be employed. For example, the order of certain of the illustrated blocks may be changed, certain of the illustrated blocks may be optional, and/or certain of the illustrated blocks may not be employed.

In operation of this embodiment, the user of the user device executes the software to create one or more architectural drawings indicating the positions of one or more embedments along a concrete form and saves the one or more architectural drawings as one or more electronic architectural drawing files on the user device. Thereafter, the website or application enables the user to upload the electronic architectural drawing file(s) directly to the server over the network. As illustrated in block 310, after receiving the uploaded electronic architectural drawing file(s), the server extracts embedment positioning information from the electronic architectural drawing file(s). The embedment positioning information associated with the positions of the one or more embedments along the concrete form. Using the extracted embedment positioning information, the server determines, for each of the one or more embedments, a desired position of that embedment along a concrete form, as indicated by block 320. The server causes the embedment positioning tape printer to print the desired positions of the one or more embedments along the concrete form on an embedment positioning tape, as indicated by block 330. The embedment positioning tape is then sent or otherwise provided to the user.

In certain embodiments, the one or more electronic architectural drawing files include information in addition to the embedment positioning information that the embedment positioning tape forming system may extract and cause the embedment positioning tape printer to print onto the embedment positioning tape, such as the position of one or more control lines along the concrete form, the name of the jobsite, and the location of the jobsite.

The present disclosure contemplates a variety of different systems each having one or more of a plurality of different features, attributes, or characteristics. It should be appreciated that a system as used herein refers to various configurations of: (a) one or more central servers, central controllers, or remote hosts; and/or (b) one or more embedment positioning tape printers. For brevity and clarity, unless specifically stated otherwise, “central server, central controller, or remote host” as used herein represents one central server, central controller, or remote host or a plurality of central servers, central controllers, or remote hosts.

The central server, central controller, or remote host is any suitable computing device (such as a server) that includes at least one processor and at least one memory device or storage device. The user device includes at least one user device processor configured to transmit and receive data or signals representing events, messages, commands, or any other suitable information between the user device and the central server, central controller, or remote host. The at least one processor of that user device is configured to execute the events, messages, or commands represented by such data or signals in conjunction with the operation of the user device. Moreover, the at least one processor of the central server, central controller, or remote host is configured to transmit and receive data or signals representing events, messages, commands, or any other suitable information between the central server, central controller, or remote host and the user device. The at least one processor of the central server, central controller, or remote host is configured to execute the events, messages, or commands represented by such data or signals in conjunction with the operation of the central server, central controller, or remote host. It should be appreciated that one, more, or each of the functions of the central server, central controller, or remote host may be performed by the at least one processor of the user device. It should be further appreciated that one, more, or each of the functions of the at least one processor of the user device may be performed by the at least one processor of the central server, central controller, or remote host.

It should be appreciated that, in various embodiments, the network is any suitable data network, such as the Internet, an intranet, an internet, a mobile communications network, a local area network (LAN), or a wide area network (WAN). It should be appreciated that the central server, central controller, or remote host and the user device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium.

### Embedment Markers

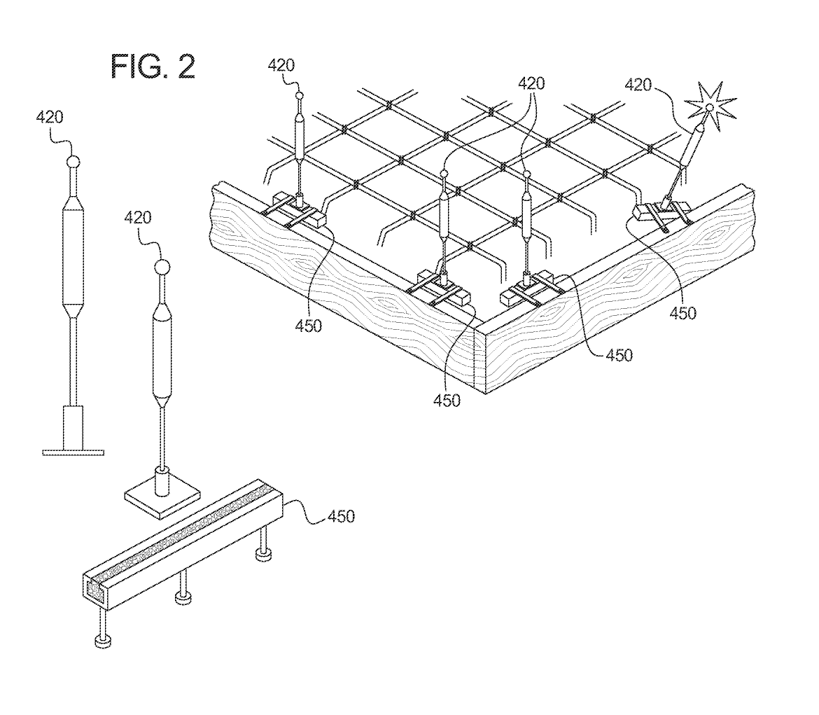

Turning now to FIG. 2, in another embodiment, the present disclosure provides a plurality of embedment markers, which are generally indicated by numerals 420. In operation, one or more users attach the embedment markers 420 to embedments 450 either before or after the embedments are attached to the concrete form such that after those embedments are attached to the concrete form, the embedment markers act as visual indicators of the positions of the embedments. This enables the users to quickly and easily verify the total number of embedments as well as the positions of those embedments along the edge of the concrete form.

In one embodiment, the embedment markers include magnetic bases that enable the embedment markers to be easily attached to and detached from the embedments. Such embedment markers are readily reusable.

In certain embodiments, each embedment marker includes a level sensor. In one such embodiment, each embedment marker is configured to emit an audible signal if the embedment to which the embedment marker is attached is out of level by more than a designated amount. In another such embodiment, each embedment marker is configured to emit a lighted signal (e.g., a flashing light) if the embedment to which the embedment marker is attached is out of level by more than a designated amount. Thus, in these embodiments, the embedment markers enable users to quickly and easily verify whether the embedments are sufficiently level as well as to verify the total number of embedments and the positions of those embedments along the edge of the concrete form.

In other embodiments, each embedment marker includes a transmitter configured to communicate embedment position information representing a position of that embedment marker (and, therefore, the position of the embedment attached thereto) to a receiver unit. The receiver unit stores or is configured to access a master embedment layout including the desired position of each embedment, and is configured to compare the received embedment position information with the master embedment layout to verify that each embedment is positioned correctly according to the master embedment layout. The receiver unit may also verify that the total number of embedments is equal to the total number of embedments included in the master embedment layout. In one such embodiment, each embedment marker is also configured to communicate to the receiver unit embedment level information representing whether the embedment to which the embedment marker is attached is sufficiently level.

The embedment markers of the present disclosure solve certain of the above-described problems. The embedment markers enable users to easily verify whether the embedments are in the correct positions along the edge of the concrete form both before and after the concrete is poured. The embedment markers thus eliminate the time required to make such determinations as well as the associated labor costs. Further, in certain embodiments, the embedment markers automatically alert users when the embedments to which they are attached are not sufficiently level, which eliminates the time required to manually make such determinations as well as the associated labor costs.

### Embedment Positioning System

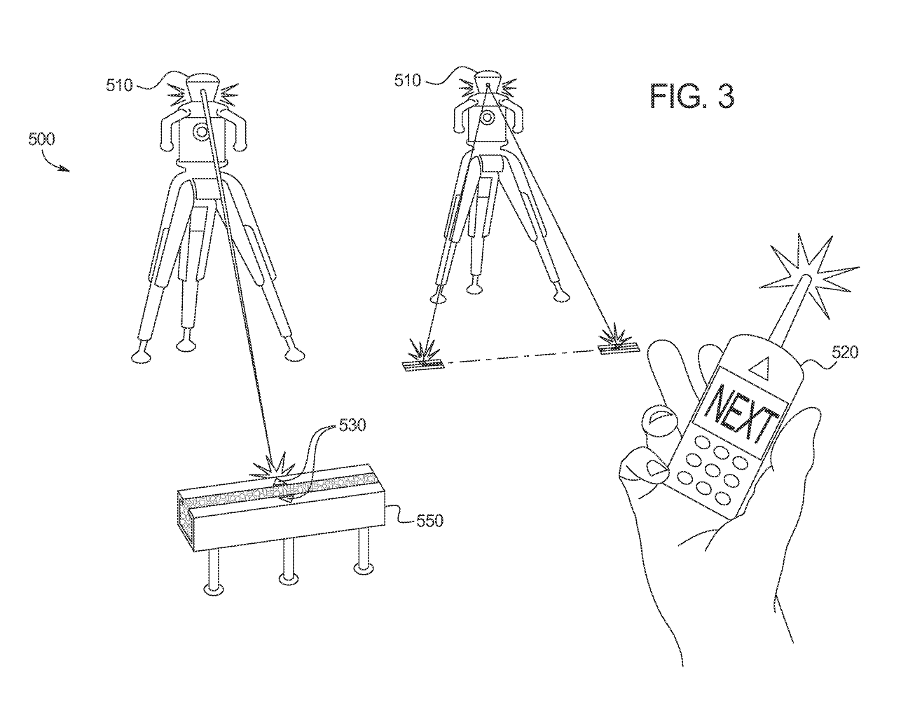

Turning now to FIG. 3, in another embodiment, the present disclosure provides an embedment positioning system, which is generally indicated by numeral 500. The embedment positioning system 500 includes a base transmitter unit 510, a receiver 520, and a plurality of embedments 550 each including one or more targets 530. In operation, a user brings an embedment 550 to the general position at which the embedment 550 is to be positioned along the edge of the concrete form. The base transmitter unit 510 sends a signal (such as a laser signal) to the embedment 550 as the user moves the embedment 550 along the edge of the concrete form. The user moves the embedment 550 along the edge of the concrete form until the target 530 on the embedment 550 lights up, glows, or otherwise provides an indication. When the target 530 on the embedment 550 provides this indication, the user attaches the embedment 550 to the concrete form. The indication thus notifies the user that the embedment is at the correct position along the edge of the concrete form.

Once the embedment attached to the concrete form, the user actuates a “confirm.” “next,” or other suitable button on the receiver 520, which may be a handheld receiver, a personal digital assistant (PDA), a smartphone, a tablet computing device, a laptop computing device, or any other suitable device. This indicates to the base transmitter unit 520 that the user is ready to position the next embedment (if any). The user then brings another embedment to the general position at which the embedment is to be positioned along the edge of the concrete form and repeats this process.

In certain embodiments, the base transmitter unit includes a camera configured to periodically take pictures of the positions of the anchored embedments. The base transmitter unit then compares the positions of the anchored embedments shown in the pictures to a master embedment layout that includes the desired position of each embedment. This enables the base unit to perform periodic checks to verify that the embedments have been correctly positioned. In one embodiment, the base unit stores data representing the positions of the embedments.

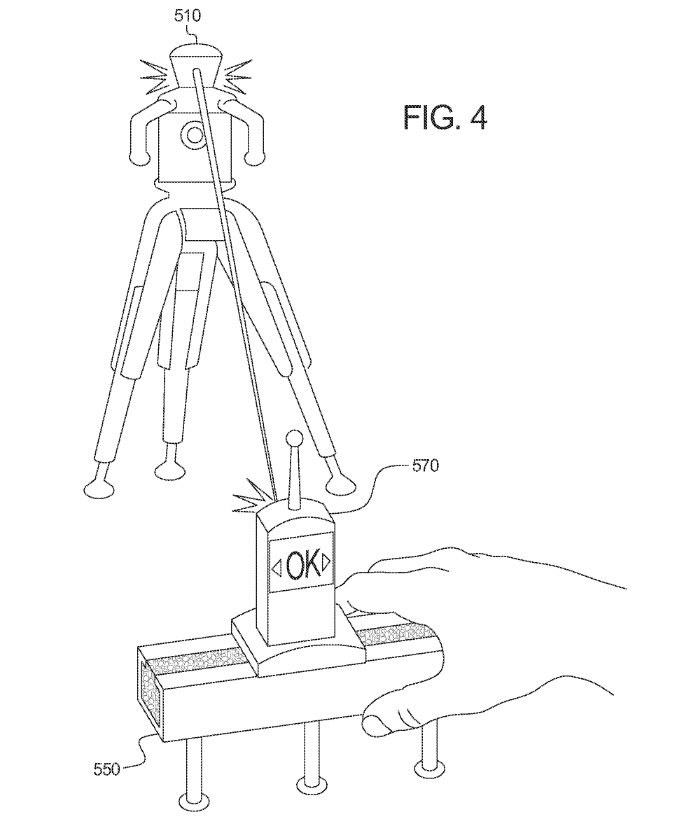

FIG. 4 illustrates another embodiment of the embedment positioning system. In operation of this embodiment, a user positions an embedment positioning receiver 570 at the center of an embedment 550. The base transmitter unit 510 communicates the desired position of the embedment 550 along the edge of the concrete form to the embedment positioning receiver 570. The embedment positioning receiver 570 displays, emits, or otherwise indicates directional signals that indicate where the user should position the embedment 550. Thus, in this embodiment, the embedment positioning system provides real-time directional signals to the user to aid the user in positioning the embedment.

The embedment positioning system of the present disclosure solves certain of the above-described problems. The embedment positioning system highlights precisely where the embedments are to be positioned along the edge of the concrete form and eliminates the need for users to use a tape measure to hand-measure the positions of the embedments and, therefore, eliminates the potential for human error in those measurements. The embedment positioning system thus eliminates the time required to make such measurements as well as the associated labor costs. Further, the embedment positioning system enables users to easily verify whether the embedments are in the correct positions along the edge of the concrete form before and after the concrete is poured. Additionally, the embedment positioning system eliminates the time and labor required to manually make such determinations as well as the costs associated with this labor.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An embedment positioning tape forming system comprising:
an embedment positioning tape printer; and
at least one server including at least one processor and at least one memory device that stores a plurality of instructions which, when executed by the at least one processor, cause the at least one processor to:
(a) receive a data file, said received data file representing embedment positioning information extracted from an electronic architectural drawing file;
(b) process the received data file and determine, for each of one or more embedments, a desired position of said embedment along a concrete form; and
(c) cause the embedment positioning tape printer to print the desired positions of the one or more embedments on an embedment positioning tape.

2. The embedment positioning tape forming system of claim 1, wherein the data file is received from a user device.

3. The embedment positioning tape forming system of claim 2, wherein the data file is created by a plug-in associated with a software program installed on the user device.

4. The embedment positioning tape forming system of claim 1, wherein the data file is received through a data network.

5. The embedment positioning tape forming system of claim 4, wherein the data network is an internet.

6. A method of operating an embedment positioning tape forming system, said method comprising:
(a) causing at least one processor to execute a plurality of instructions to receive a data file, said received data file representing embedment positioning information extracted from an electronic architectural drawing file;
(b) causing the at least one processor to execute the plurality of instructions to process the received data file and determine, for each of one or more embedments, a desired position of said embedment along a concrete form; and
(c) causing the at least one processor to execute the plurality of instructions to cause an embedment positioning tape printer to print the desired positions of the one or more embedments on an embedment positioning tape.

7. The method of claim 6, wherein the data file is received from a user device.

8. The method of claim 7, wherein the data file is created by a plug-in associated with a software program installed on the user device.

9. The method of claim 6, wherein the data file is received through a data network.

10. The method of claim 9, wherein the data network is an internet.

11. An embedment positioning tape forming system comprising:
an embedment positioning tape printer; and
at least one server including at least one processor and at least one memory device that stores a plurality of instructions which, when executed by the at least one processor, cause the at least one processor to:
(a) receive an electronic architectural drawing file;
(b) extract embedment positioning information from the received electronic architectural drawing file;
(c) using the extracted embedment positioning information, determine, for each of one or more embedments, a desired position of said embedment along a concrete form; and
(d) cause the embedment positioning tape printer to print the desired positions of the one or more embedments on an embedment positioning tape.

12. The embedment positioning tape forming system of claim 11, wherein the electronic architectural drawing file is received through an upload to the at least one server.

13. The embedment positioning tape forming system of claim 12, wherein the electronic architectural drawing file is created by a user of a user device from which the electronic architectural drawing file is uploaded to the at least one server.

14. The embedment positioning tape forming system of claim 11, wherein the electronic architectural drawing file is received through a data network.

15. The embedment positioning tape forming system of claim 14, wherein the data network is an internet.

16. A method of operating an embedment positioning tape forming system, said method comprising:
(a) causing at least one processor to execute a plurality of instructions to an electronic architectural drawing file;
(b) causing the at least one processor to execute the plurality of instructions to extract embedment positioning information from the received electronic architectural drawing file;
(c) using the extracted embedment positioning information, causing the at least one processor to execute the plurality of instructions to determine, for each of one or more embedments, a desired position of said embedment along a concrete form; and
(d) causing the at least one processor to execute the plurality of instructions to cause an embedment positioning tape printer to print the desired positions of the one or more embedments on an embedment positioning tape.

17. The method of claim 16, wherein the electronic architectural drawing file is received through an upload to the at least one server.

18. The method of claim 17, wherein the electronic architectural drawing file is created by a user of a user device from which the electronic architectural drawing file is uploaded to the at least one server.

19. The method of claim 16, wherein the electronic architectural drawing file is received through a data network.

20. The method of claim 19, wherein the data network is an internet.
